(19) United States
(12) Patent Application Publication
(10) Pub. No.: US 2019/0146152 A1
(43) Pub. Date: May 16, 2019

(54) Waveguide Array Module and Receiver Optical Sub-Assembly

(71) Applicant: Source Photonics (Chengdu) Company, Ltd., Chengdu (CN)

(72) Inventor: Yung-Cheng CHANG, Chengdu (CN)

(73) Assignee: Source Photonics (Chengdu) Company , Ltd., Chengdu (CN)

(21) Appl. No.: 15/748,516

(22) PCT Filed: Nov. 15, 2017
(86) PCT No.: PCT/CN2017/111065

§ 371 Date: Jan. 29, 2018

(51) Int. Cl. G02B 6/12; G02B 6/42; G02B 6/06; F21V 8/00

(52) U.S. Cl. CPC G02B 6/12007; G02B 6/0016; G02B 6/06; G02B 6/4204

(57) ABSTRACT

A waveguide array module according to some embodiments of the present disclosure includes a lens array and a waveguide component. The lens array is configured to output a plurality of light beams of different wavelengths. The waveguide component includes a plurality of waveguide channels configured to respectively direct the plurality of light beams. Each of the waveguide channels includes an input port on a first surface facing the lens array and configured to receive a respective one of the light beams, and an output port on a second surface non-parallel to the first surface and configured to output the respective one of the light beams.

### TECHNICAL FIELD

The present disclosure relates to a waveguide array module and a receiver optical sub-assembly (ROSA), and more particularly to a waveguide array module and a receiver optical sub-assembly with compact size and thin profile.

### BACKGROUND

A receiver optical sub-assembly (ROSA) is one of the key sub-assemblies in an optical telecommunication device. The conventional ROSA uses a reflection mirror to direct the light beams from a de-multiplexer (DEMUX) to an optical receiving component. The reflection mirror, however, has a thick profile, and thus increases the overall volume of the ROSA. In addition, the reflection mirror may reflect the light beams from the optical receiving component back to the DEMUX; this erroneous reflection is known as return loss and deteriorates the performance of the ROSA.

This Background section is provided for background information only. The statements in this Background section are not an admission that the subject matter disclosed in this section constitutes prior art to the present disclosure, and no part of this Background section may be used as an admission that any part of this application, including this Background section, constitutes prior art to the present disclosure.

### SUMMARY

One aspect of the present disclosure provides a waveguide array module and a receiver optical sub-assembly with compact size and thin profile.

A waveguide array module according to some embodiments of the present disclosure includes a lens array and a waveguide component. The lens array is configured to output a plurality of light beams of different wavelengths. The waveguide component includes a plurality of waveguide channels configured to respectively direct the plurality of light beams. Each of the waveguide channels includes an input port on a first surface facing the lens array and configured to receive a respective one of the light beams, and an output port on a second surface non-parallel to the first surface and configured to output the respective one of the light beams.

In some embodiments, the waveguide channels are arranged and equally spaced in a direction.

In some embodiments, the waveguide component further includes a third surface inclined with respect to the first surface and the second surface, wherein the third surface is configured to direct the light beams from the first surface to the second surface.

In some embodiments, the light beams are reflected by the third surface.

In some embodiments, an included angle between the second surface and the third surface is substantially in a range from about 40 degrees to about 45 degrees.

In some embodiments, the waveguide channels comprise a plurality of optic fibers.

In some embodiments, the waveguide component further comprises a base plate including a plurality of grooves configured to dispose or support the waveguide channels, respectively.

In some embodiments, the waveguide array module further includes an optical receiving component facing the output ports of the waveguide component and configured to couple or receive the light beams from the waveguide component.

In some embodiments, the optical receiving component includes a light incident surface, wherein the light incident surface is not perpendicular to the light beams output from the output ports of the waveguide component.

In some embodiments, the optical receiving component includes a light incident surface, wherein the light incident surface is perpendicular to the light beams output from the output ports of the waveguide component.

In some embodiments, the waveguide component further comprises a plurality of focusing lenses on the second surface and configured to focus the light beams from the output ports of the waveguide component.

In some embodiments, the light beams from the lens array are focused light beams.

A receiver optical sub-assembly (ROSA) according to some embodiments of the present disclosure includes the aforementioned waveguide array module and a de-multiplexer (DEMUX). The DEMUX is adjacent to the lens array and is configured to separate a multiple-wavelength light beam into a plurality of light beams with narrow spectral bands for the waveguide array module.

The waveguide array module and the ROSA include a lens array and a waveguide component. The waveguide component can receive the light beams from the lens array, and can redirect the light beams to an optical receiving component. The waveguide component does not require a large reflection mirror to redirect the light beams, and thus is thinner than comparable devices requiring a reflection mirror. Accordingly, the overall volume of the waveguide array module can be reduced. The waveguide array module can also prevent the light beams from being reflected back by the optical receiving component, and thus the waveguide array module can mitigate return loss. Accordingly, the performance can be improved.

The foregoing has outlined rather broadly the features and technical advantages of the present disclosure in order that the detailed description of the disclosure that follows may be better understood. Additional features and advantages of the disclosure will be described hereinafter, and form the subject of the claims of the disclosure. It should be appreciated by those skilled in the art that the conception and specific embodiments disclosed may be readily utilized as a basis for modifying or designing other structures or processes for carrying out the same purposes as those of the present disclosure. It should also be realized by those skilled in the art that such equivalent constructions do not depart from the spirit and scope of the disclosure as set forth in the appended claims.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures, and:

FIG. 1 is a schematic diagram of a waveguide array module according to some embodiments of the present disclosure;

FIG. 2 is a schematic top view of a waveguide array module according to some embodiments of the present disclosure;

FIG. 3 is a schematic side view of a waveguide array module from one direction according to some embodiments of the present disclosure;

FIG. 4 is a schematic side view of a waveguide array module from another direction according to some embodiments of the present disclosure;

FIG. 5 is a schematic exploded view of a waveguide component according to some embodiments of the present disclosure;

FIG. 6 is a schematic view of a waveguide array module according to some embodiments of the present disclosure; and

FIG. 7 is a schematic view of a receiver optical sub-assembly (ROSA) according to some embodiments of the present disclosure.

### DETAILED DESCRIPTION

The following description of the disclosure accompanies drawings, which are incorporated in and constitute a waveguide array module and a receiver optical sub-assembly (ROSA) of this specification, and illustrate embodiments of the disclosure, but the disclosure is not limited to the embodiments. In addition, the following embodiments can be properly integrated to complete another embodiment.

References to “one embodiment,” “an embodiment,” “exemplary embodiment,” “some embodiments,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

In order to make the present disclosure completely comprehensible, detailed steps and structures are provided in the following description. Obviously, implementation of the present disclosure does not limit special details known by persons skilled in the art. In addition, known structures and steps are not described in detail, so as not to limit the present disclosure unnecessarily. Preferred embodiments of the present disclosure will be described below in detail. However, in addition to the detailed description, the present disclosure may also be widely implemented in other embodiments. The scope of the present disclosure is not limited to the detailed description, and is defined by the claims.

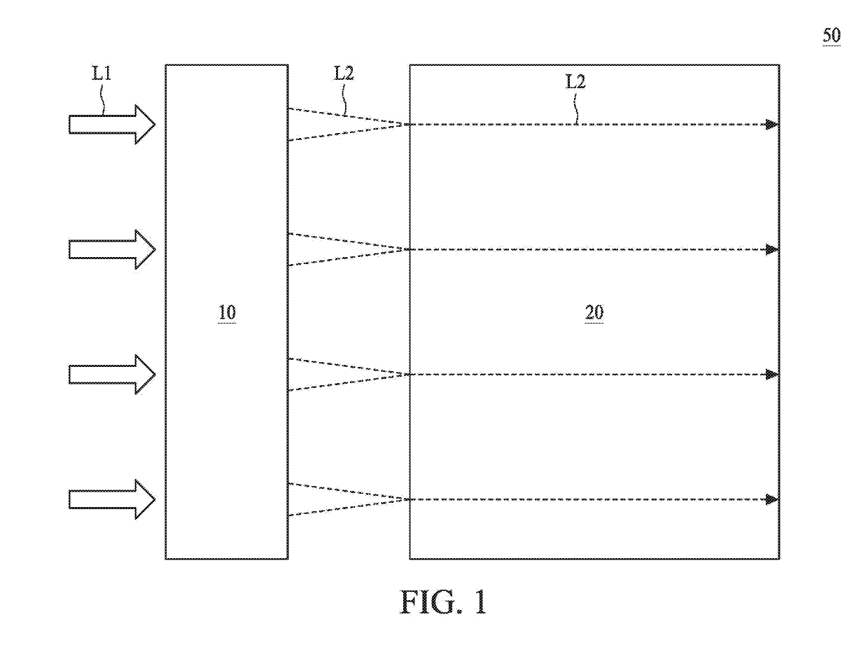

FIG. 1 is a schematic diagram of a waveguide array module according to some embodiments of the present disclosure. As shown in FIG. 1, the waveguide array module 50 includes a lens array 10 and a waveguide component 20. In some embodiments, the waveguide array module 50 may be part of a sub-assembly of an optical receiving device such as a receiver optical sub-assembly (ROSA), but is not limited thereto. The waveguide array module 50 may be configured to receive collimated light beams, transform the collimated light beams into focused light beams, and direct and/or couple the focused light beams to an optical receiving component.

In some embodiments, the lens array 10 is configured to receive a plurality of light beams L1, and output a plurality of light beams L2. In some exemplary embodiments, the light beams L1 are light beams of different wavelengths output from a de-multiplexer (DEMUX). By way of example, four light beams L1 having wavelengths of about 1270 nm, 1290 nm, 1310 nm and 1330 nm are input to the lens array 10. In some embodiments, the light beams L1 may be collimated light beams. The collimated light beams entering the lens array 10 can be focused by the lens array, and output as the light beams L2 having the same wavelengths as the light beams L1 respectively.

In some embodiments, the waveguide component 20 is a multi-channel waveguide component, which may guide the light beams L2, and may output the light beams L2 in another direction without a reflection mirror. Accordingly, the size and thickness of the waveguide array module 50 can be reduced.

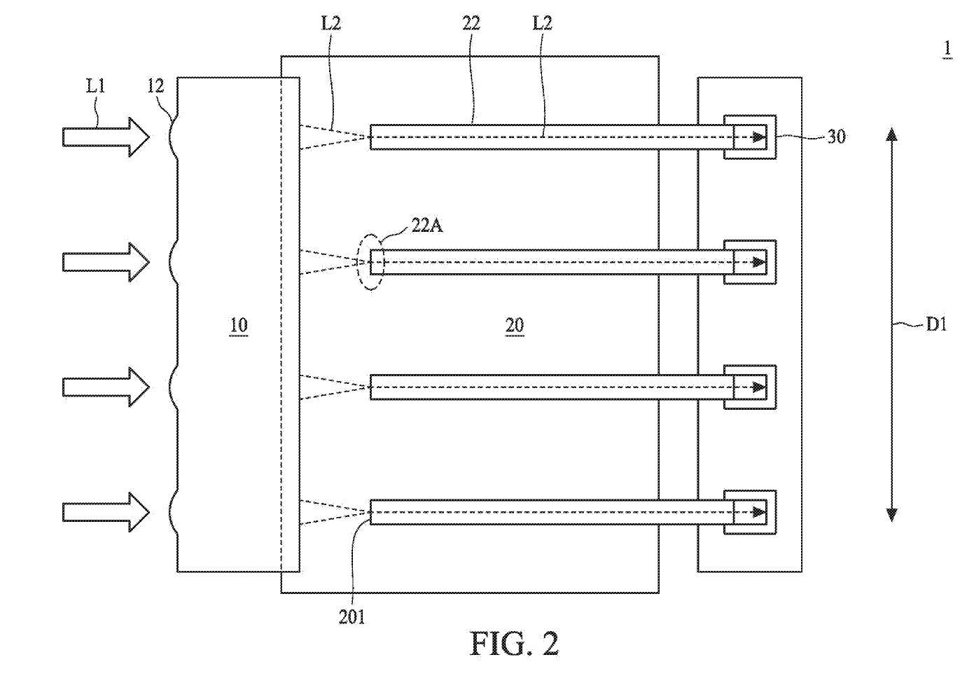

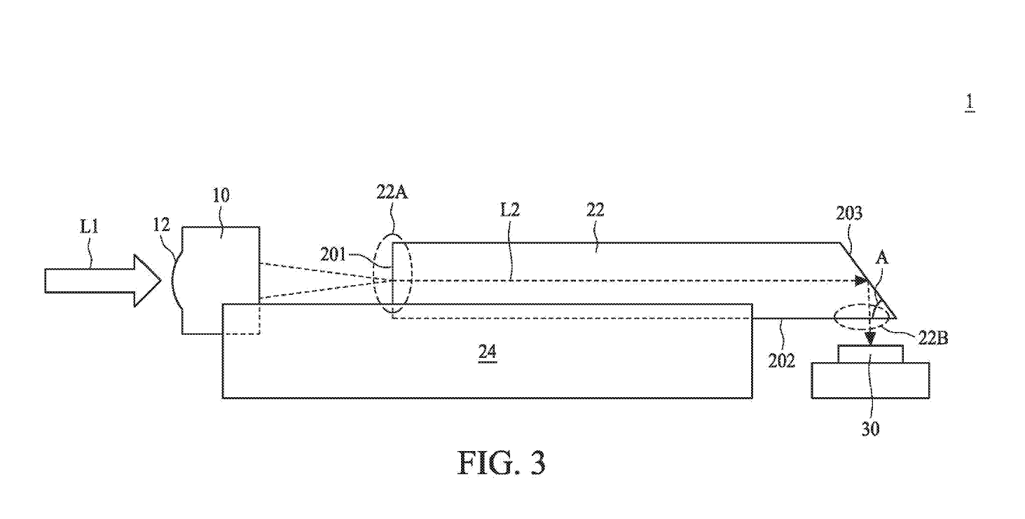

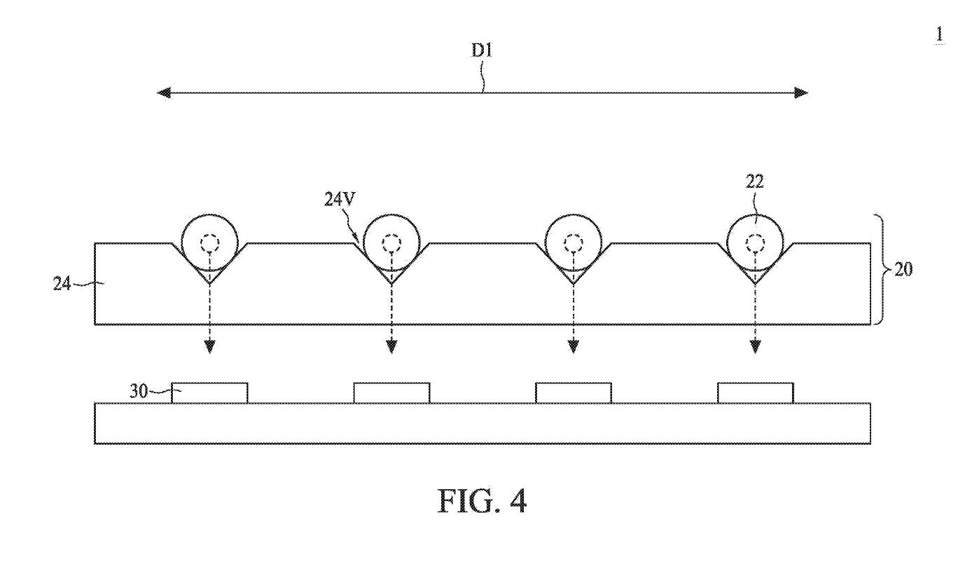

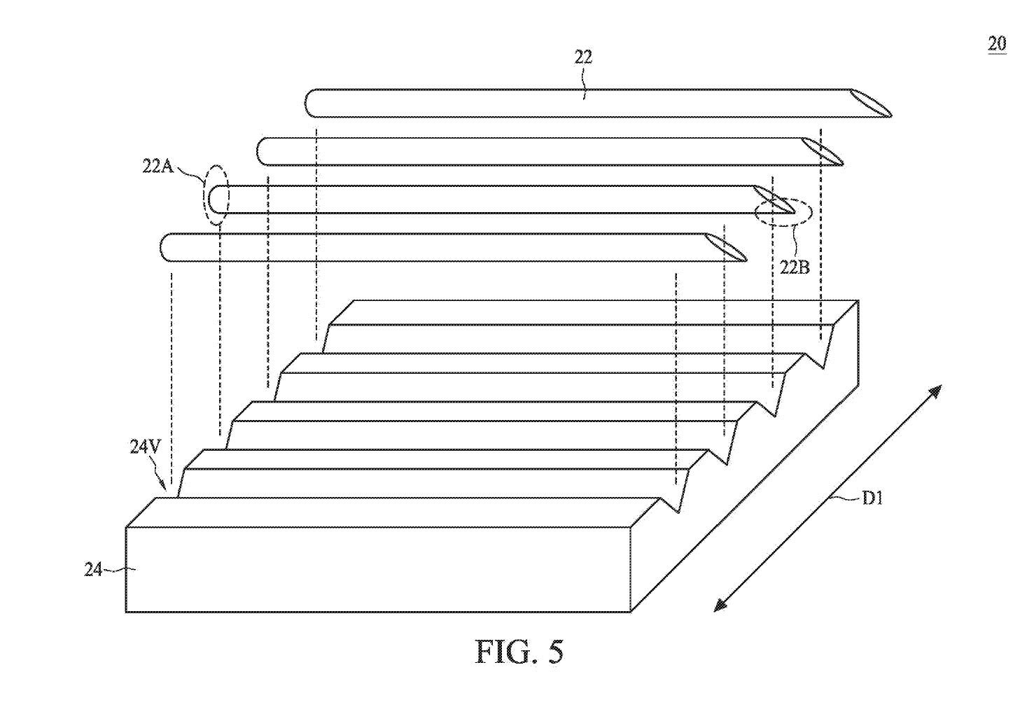

Refer to FIG. 2, FIG. 3, FIG. 4 and FIG. 5. FIG. 2 is a schematic top view of a waveguide array module according to some embodiments of the present disclosure, FIG. 3 is a schematic side view of a waveguide array module from one direction according to some embodiments of the present disclosure, FIG. 4 is a schematic side view of a waveguide array module from another direction according to some embodiments of the present disclosure, and FIG. 5 is a schematic exploded view of a waveguide component according to some embodiments of the present disclosure. As shown in FIG. 2, FIG. 3 and FIG. 4, the waveguide array module 1 includes a lens array 10 and a waveguide component 20. The lens array 10 is configured to couple a plurality of light beams L1 of different wavelengths. For example, four light beams L1 having wavelengths of about 1270 nm, 1290 nm, 1310 nm and 1330 nm are input to the lens array 10. In some embodiments, the light beams L1 are collimated before entering the lens array 10. In some embodiments, the lens array 10 may include a plurality of lenses 12 arranged corresponding to the light beams L1 for focusing the light beams L1 and outputting a plurality of light beams L2 to the waveguide component 20. In some embodiments, the light beams L2 output from the lens array 10 are focused light beams.

The waveguide component 20 includes a plurality of waveguide channels 22 configured to respectively direct the light beams L2. In some embodiments, each of the waveguide channels 22 includes an input port 22A and an output port 22B. The input ports 22A are disposed on a first surface 201 facing the lens array 10, and the input ports 22A are configured to receive the light beams L2, respectively. The output ports 22B are disposed on a second surface 202 non-parallel to the first surface 201 and configured to respectively output the the light beams L2, as shown in FIG. 3.

In some embodiments, the waveguide channels 22 are arranged and equally spaced in a direction D1. By way of example, the pitch between any two adjacent waveguide channels 22 is about 750 micrometers, but the pitch is not limited thereto. In some embodiments, the waveguide channels 22 may include a plurality of optic fibers, but the waveguide channels 22 are not limited thereto. The waveguide channels 22 may include other waveguide components such as polymer waveguide components, ion exchanged waveguide components or the like. In some embodiments, the waveguide component 20 further includes a third surface 203 that is angled or inclined with respect to the first surface 201 and the second surface 202, and configured to direct the light beams L2 from the first surface 201 to the second surface 202. In some embodiments, the waveguide channels 22 may include a plurality of optic fibers, and the light beams L2 may be reflected by the third surface 203 and redirected to the second surface 202 due to total internal reflection. In some exemplary embodiments, an included angle A between the second surface 202 and the third surface 203 is substantially in a range from about 40 degrees to about 45 degrees, but the included angle A is not limited thereto.

As shown in FIG. 5, the waveguide component 20 may further include a base plate 24 including a plurality of grooves 24V configured to dispose the waveguide channels 22, respectively. In some embodiments, the grooves 24V may be V-shaped grooves, semicircle shaped grooves, or grooves of other suitable shapes. The grooves 24V are equally spaced in the direction D1 such that the waveguide channels 22 disposed therein can be equally spaced in the direction D1.

In some embodiments, the waveguide array module 1 may further include one or more optical receiving components 30 such as photodiode components facing the output ports 22B of the waveguide component 20. The optical receiving components 30 are responsive to the light beams L2 from the waveguide component 20. In some embodiments, the light beams L2 from the waveguide component 20 are emitted to the optical receiving components 30 at an angle such that the light beams L2 will not be reflected back to the waveguide component 20 along the original light path. Accordingly, return loss can be mitigated.

In some embodiments of the present disclosure, the waveguide array module 1 uses the lens array 10 and the waveguide component 20 to guide and redirect the light beams L2 to the optical receiving components 30. In a comparative embodiment, the lens array uses a reflection mirror to direct the light beams to redirect the light beams to the optical receiving components 30. In contrast to the comparative embodiment, the waveguide component 20 of the embodiments of the present disclosure is thinner, and thus can reduce the overall volume of the waveguide array module 1. In addition, the waveguide array module 1 can prevent the light beams from being reflecting back by the optical receiving components 30, and thus the waveguide array module 1 can mitigate return loss. Accordingly, the performance can be improved.

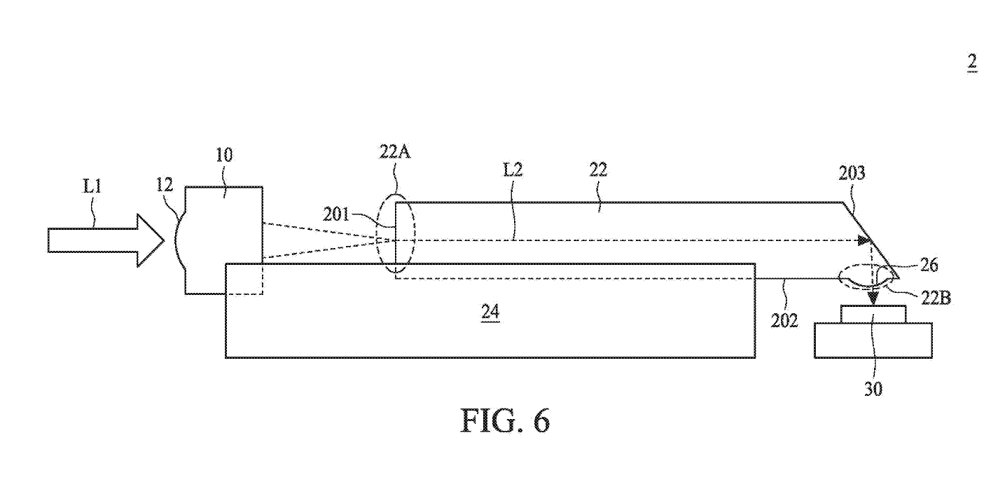

FIG. 6 is a schematic view of a waveguide array module 2 according to some embodiments of the present disclosure. In contrast to the waveguide array module 1 of FIG. 2, FIG. 3, FIG. 4 and FIG. 5, the waveguide array module 2 includes one or more focusing lenses 26 in the output ports 22B of the waveguide component 20. The focusing lenses 26 are disposed on the second surface 202 of the waveguide component 20, and correspond to the optical receiving components 30. The focusing lenses 26 are configured to focus the light beams L2 such that the light beams L2 from the waveguide component 20 can be accurately input to the optical receiving components 30. In some embodiments, the focusing lenses 26 may be integrally formed with the waveguide channels 22. For example, the focusing lenses 26 and the waveguide channels 22 may be monolithically formed from the same material.

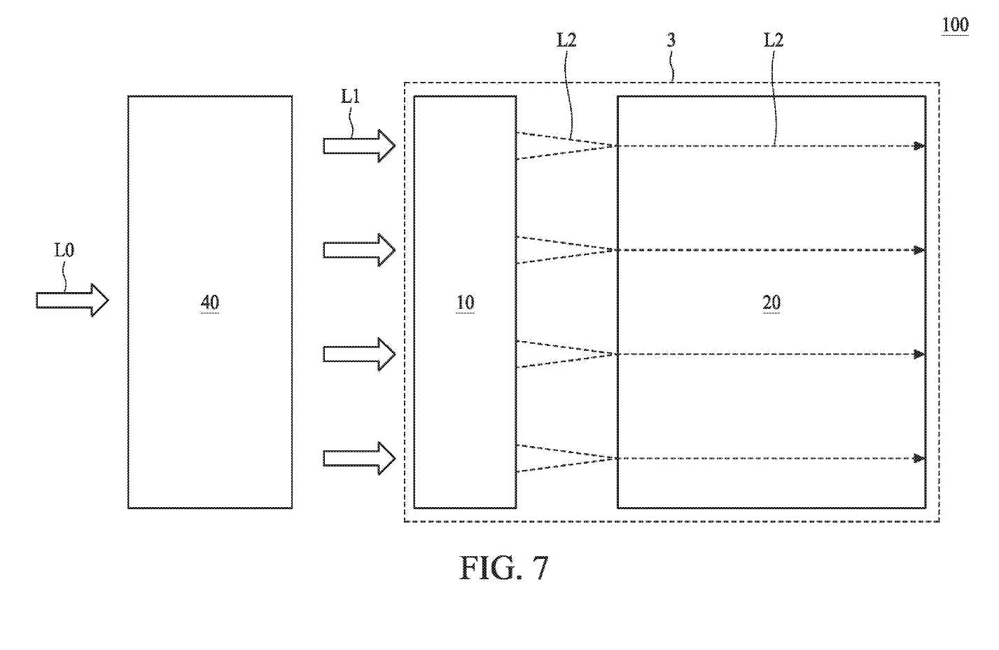

FIG. 7 is a schematic view of a receiver optical sub-assembly (ROSA) according to some embodiments of the present disclosure. As shown in FIG. 7, the ROSA 100 may include one or more waveguide array modules 3 and a de-multiplexer (DEMUX) 40. In some embodiments, the one or more waveguide array modules 3 may include the waveguide array module 1 and/or the waveguide array module 2 of the aforementioned embodiments. The DEMUX 40 is disposed adjacent to the lens array 10 and is configured to separate a multiple wavelength light beam L0 into a plurality of light beams L1 with narrow spectral bands for the waveguide array module 3.

In some embodiments of the present disclosure, the waveguide array module includes a lens array and a waveguide component. The waveguide component can receive the light beams from the lens array, and can redirect the light beams to an optical receiving component. The waveguide component does not require a large reflection mirror to redirect the light beams, and thus is thinner in comparison to other methods which use a lens array with a large reflection mirror. Accordingly, the overall volume of the waveguide array module can be reduced. The waveguide array module can also prevent the light beams from being reflected back by the optical receiving component, and thus the waveguide array module can mitigate return loss. Accordingly, the performance can be improved.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A waveguide array module, comprising:
a lens array configured to output a plurality of light beams of different wavelengths;
a waveguide component comprising (a) a plurality of waveguide channels configured to respectively direct the plurality of light beams and (b) a base plate including a plurality of V-shaped or semicircle-shaped grooves configured to support the waveguide channels, wherein (i) each of the waveguide channels includes an input port on a first surface facing the lens array and configured to receive a respective one of the light beams, an output port on a second surface non-parallel to the first surface and configured to output the respective one of the light beams, and a third surface at an angle in a range from about 40 degrees to about 45 degrees with respect to the first surface and the second surface, configured to direct the light beams from the first surface to the second surface, and (ii) the waveguide channels comprise a plurality of optical fibers equally spaced along a direction perpendicular to the plurality of light beams; and
an optical receiving component facing the output ports of the waveguide component and configured to receive the light beams from the waveguide component.

2-8. (canceled)

9. The waveguide array module of claim 1, wherein the optical receiving component includes a light incident surface, and the light incident surface is not perpendicular to the light beams from the output ports of the waveguide component.

10. The waveguide array module of claim 1, wherein the optical receiving component includes a light incident surface, and the light incident surface is perpendicular to the light beams from the output ports of the waveguide component.

11. The waveguide array module of claim 1, wherein the waveguide component further comprises a plurality of focusing lenses on the second surface and configured to focus the light beams from the output ports of the waveguide component.

12. The waveguide array module of claim 1, wherein the light beams from the lens array are focused light beams.

13. A receiver optical sub-assembly (ROSA), comprising:
the waveguide array module of claim 1; and
a de-multiplexer (DEMUX) adjacent or proximate to the lens array and configured to separate a multiple wavelength light beam into the plurality of light beams, each of the plurality of light beams having a narrow spectral band.

14. The ROSA of claim 13, wherein the plurality of waveguide channels comprises four or more parallel optical fibers.

15. The ROSA of claim 14, wherein DEMUX separates the multiple wavelength light beam into at least four light beams, each having a different wavelength and entering a different one of the plurality of waveguide channels.

16. The ROSA of claim 14, wherein a volume of the ROSA is less than that of an otherwise identical ROSA including a reflection mirror adjacent to the lens array replacing the waveguide array.

17. The waveguide array module of claim 1, wherein the plurality of waveguide channels are partially below an uppermost surface of the base plate, thereby enabling the plurality of V-shaped or semicircle-shaped grooves to reduce a height of the waveguide component.

18. The waveguide array module of claim 17, wherein a midpoint or center of each of the plurality of waveguide channels is below the uppermost surface of the base plate.

19. The waveguide array module of claim 1, wherein the plurality of waveguide channels comprises four or more optical fibers.

20. The waveguide array module of claim 19, wherein the four or more optical fibers are parallel to each other.

21. The waveguide array module of claim 1, wherein the second surface is at an angle of 90° with respect to the first surface.

22. The waveguide array module of claim 1, wherein the base plate contacts or supports the lens array and the waveguide component.

23. The waveguide array module of claim 1, wherein each of the optical fibers extends past an outermost edge of the base plate so that the output port on the second surface of each optical fiber is exposed by the base plate.

24. The waveguide array module of claim 1, wherein bottommost surfaces of the baseplate and the optical receiving component are coplanar.

25. The waveguide array module of claim 1, wherein the plurality of light beams are collimated.

26. The waveguide array module of claim 1, wherein the lens array is integral and/or monolithic with the waveguide channels.

27. The waveguide array module of claim 1, wherein the waveguide channels include polymer waveguide components or ion exchanged waveguide components.
